(19) United States
(12) Patent Application Publication
(10) Pub. No.: US 2016/0140604 A1
(43) Pub. Date: May 19, 2016

(54) CUSTOMER TRANSACTION PROMPTING ADVERTISEMENT PRESENTMENT AND IMPRESSIONS

(71) Applicant: BANK OF AMERICA CORPORATION, Charlotte, NC (US)

(72) Inventors: Jason P. Blackhurst, Charlotte, NC (US); Frederick A. Shahda, Charlotte, NC (US); Robert L. Abbott, Charlotte, NC (US); Alfred Hamilton, Charlotte, NC (US)

(21) Appl. No.: 14/541,789

(22) Filed: Nov. 14, 2014

(51) Int. Cl. G06Q 30/02

(52) U.S. Cl. CPC G06Q 30/0246

(57) ABSTRACT

Embodiments of the invention are directed to a system, method, or computer program product for advertisement presentment based on customer transactions at a brick and mortar merchant location. The invention compiles transaction data across a financial institution for transactions with a merchant. The system generalizes the transaction data across the financial institution based on category of product or merchant associated with the transaction. Subsequently, the generalized data may be presented to an advertiser for correlating recent brick and mortar purchases of a customer to advertisements to present to a customer online or offline in the future. Furthermore, the transaction data may include data identifying the specific products purchased by the customer. In this way, the specific product data may match to advertisements previously viewed or presented to a customer.

### BACKGROUND

Advancements in internet technology, social media, and the like allow for a multitude of options for advertisers to advertise products and services. Furthermore, advertisers can reach a broader customer base than ever before. With these additional advertisement outlets, merchants may be able to invest more and more assets into advertising. Furthermore, this technology has allowed advertisers to more accurately target a specific audience. However, while these advancement allow for a broader customer base to potentially be reached and targeted, it remains difficult to target and track the effectiveness of any one advertisement campaign where multiple channels are being utilized for the transaction and/or the advertisements.

### BRIEF SUMMARY

Embodiments of the present invention address the above needs and/or achieve other advantages by providing apparatuses (e.g., a system, computer program product and/or other devices) and methods for advertisement presentment based on customer transactions at a brick and mortar merchant location. The invention compiles transaction data across a financial institution for transactions with merchants. The system generalizes the transaction data across the financial institution based on category of product or merchant associated with the transaction. Subsequently, the generalized data may be presented to an advertiser for correlating recent brick and mortar purchases of a customer to advertisements to present to a customer online or offline. Furthermore, the transaction data may include data identifying the specific products purchased by the customer. In this way, the specific product data may match to advertisements viewed or presented to a customer.

In some embodiments, the system may receive customer transaction data associated with customer transactions. The customer transaction data may be received from a merchant or customer. In some embodiments, the received customer transaction data includes item level data, such as a stock keeping units (SKU) or code level data. In other embodiments, the item level data may include electronic communications, such as electronic receipts, between the merchant and customer. The received customer transaction data is associated with customer transactions for the products, services, or the like purchased by the customer. The transaction data may identify one or more financial transactions of the customer for products, merchants, or services associated with a merchant. The transaction data, specifically item level data, may be identified based on electronic communications between the merchant and customer and/or stock keeping unit (SKU) identification. In some embodiments, the system may be provided with the transaction data from a financial institution. In other embodiments, the system may determine the transaction data based on the system being implemented by a financial institution. In some embodiments, the system may determine transaction data by receiving or retrieving information from the merchant, social networks, and/or the customer.

Next, the system may compile the item level transaction data across the financial institution. As such, item level transaction data may be compiled together and grouped based on a category of product, merchant, or by specific product. Subsequently, the data compiled is generalized within the financial institution. As such, the generalized information includes information about a number of customers that purchased a product, a category of products, or from a merchant within a given time period. The generalized information does not include information about the customer making a purchase, but instead general numbers associated with the number of customers that purchased a product, a category of products, or from a merchant within a given time period.

Next, the system may receive a request from an advertiser for the generalized item level transaction data for a specific merchant, product, time period, geographic location, or the like. In this way, the advertiser may request data to better target customers in future advertisements. In this way, the advertiser may be provided with information such as a number of customers purchasing the product, the location of the purchases, a time or date associated with the purchases, or the like. As such, the advertiser may have a better indication as to the demographic of individuals purchasing products from brink and mortar locations.

The system may generate advertisement correlation data based on the request from the advertiser. The advertisement correlation data filters the generalized item level transaction data based on an advertisers request for data for a specific merchant, product, category of products, geographic location, or the like.

Finally, the system may provide feedback to the advertiser for future advertisements in the form of advertisement correlation data. In this way, the advertiser may have an understanding of a target future audience based on purchases that the customer has made in the past. As such, an advertiser may be able to target advertisements based on demographic, geographical location, social network, or the like based on one or more categories of products the customer has purchased in the past. As such, this future advertisement data may be valuable to an advertiser to predict future purchases and push those advertisements to a customer based on generalized item level data received.

In some embodiments, the system may monitor customer transactions and/or receive transaction data associated with the customer transactions. Once the transaction data is received, the system may identify specific products or merchants associated with the transaction. The specific products or merchants maybe identified based on electronic communication between the merchant and customer and/or stock keeping unit (SKU) identification.

In some embodiments, the system correlates or matches the products, merchants and/or services identified by item level transaction data to advertisements that the customer has previously viewed. As such, the monitoring of customer transaction data leads the system to identifying a match between a product of the advertisement viewed and a subsequent purchase by the customer.

In some embodiments, the invention receives information indicating that advertisements were viewed by a customer. An advertiser or merchant may provide information to the system regarding the advertisements that were viewed by a customer, such as a customer identification, merchant, time period, geographic location, transaction channel, or the like associated with the advertisement.

In some embodiments, the advertisement viewed by the customer may be online. In other embodiments, the advertisement viewed by the customer may offline, such as in printed version, such as in a newspaper, magazine, billboard, or the like. For online advertisements, customer views of the website or advertisements that the customer is predicted to have viewed via a website are identified. In this way, the customer may be on one or more webpages on the internet. The customer may be presented with multiple advertisements, such as offers, deals, promotions, incentives, or the like while accessing the internet. The system may receive an indication that the customer viewed or potentially viewed the advertisements. As such, the system may retrieve, and/or receive customer advertisement impressions, which are advertisements that a customer viewed. The viewed advertisements may be identified by the customer selecting or clicking an advertisement, by scrolling over the advertisement, a duration of viewing the advertisement, customer searches and search results, social network endorsements, or the like.

For offline advertisements, one or more advertisements may be viewed or predicted to have been viewed by the customer offline. These advertisements may include billboards, magazines, newspapers, flyers, television, or the like. The customer may be presented with multiple advertisements, such as offers, deals, promotions, incentives, or the like while offline. The system may receive information associated with the advertisements viewed or potentially viewed by the customer. As such, the system receives and/or identifies customer advertisement impressions or advertisements viewed by the customer. The viewed advertisements may be identified by customer newspaper or magazine subscriptions, global positioning systems (GPS), travel routes, travel or transportation location purchases, television guides, or the like.

Once the advertisements that were viewed by the customer are identified, the invention may receive information associated with the one or more products, services, offers, promotions, or the like associated with the advertisement. In some embodiments, once the system receives the advertisements viewed by the customer, the merchant, product, service, offer, promotion, or the like associated with the advertisement is identified. In some embodiments, this information may be received from the advertiser or merchant. In other embodiments, the system may retrieve the information about the merchant or product based on knowledge of advertisement viewed by the customer, advertisement positioning, object recognition, or the like.

In this way, the system receives information regarding the advertisements that were viewed by a customer. This information including, a customer identification, merchant, time of viewing, duration of viewing, geographic location, channel of viewing, or the like associated with the advertisement. Then, the system may match this data to the item level data previously determined for customer transactions. As such, a match may identify one or more products or services purchased by the customer where the customer viewed an advertisement for that product prior to purchasing the product. In this way, indicating a positive advertisement or marketing campaign. In this way, the system may determine an advertisement interest in a category of a product, a product, or the like.

In some embodiments, feedback is provided to an advertiser based on the match along with the feedback for future advertisements in the form of advertisement correlation data. The feedback based on a match may include an amount of customers that viewed the advertisement compared to an amount of customers that purchased the products associated with that advertisement. Not only will the system provide information regarding which advertisements may be positive resulting and which are not, such that the merchant may determine the most positive advertisement campaign based on this data. The system may also provide feedback for future advertisement predictions in the form of advertisement correlation data.

In some embodiments, the system generates and provides marketing effectiveness data based on the match data and advertisement correlation data. As such, the invention generates marketing effectiveness data that tracks the advertisements and the effectiveness of the advertisements based on purchases associated with advertisement impressions and aids in predicting future marketing strategy and advertisement focusing. Along with this, the system bridges an important advertising gap between an advertisement and a subsequent brink and mortar store purchase.

Embodiments of the invention relate to systems, methods, and computer program products for advertisement presentment, the invention comprising receiving transaction data associated with a customer transaction, wherein the received customer transaction data includes SKU data and/or electronic communication data from electronic communications between a merchant and the customer; identifying item level data for products of the transaction, wherein item level data includes specific information identifying a product including a model number, name, and manufacturer of the product of the transaction; compiling the item level data across a financial institution; generalizing the item level data across the financial institution based on a category of product and/or category of merchant; receiving a request for advertisement correlation data from an advertiser, wherein the advertisement correlation data includes the generalized item level based on the category of product and/or category of merchant; matching the generalized item level data to the request; and presenting feedback for future advertisements based on the request for advertisement correlation data.

In some embodiments, the invention further comprises receiving information indicating one or more advertisements for a merchant, product, and/or service viewed by a customer; identifying the product and merchant of the advertisement viewed; matching the merchant, product, and/or service of the one or more advertisements viewed by the customer to the item level transaction data; and providing advertising effectiveness data including feedback indicating successfulness of advertisements based on a match between the viewed advertisements and item level data from the customer transactions.

In some embodiments, receiving electronic communication data includes monitoring email addresses of the customer and the merchant to identify electronic communications associated with transactions and retrieving the electronic communication data.

In some embodiments, generalizing the item level data across the financial institution based on a category of product and merchant includes removing customer information from the item level data and correlating each of the products of each of the transactions for the item level data into a category of product and/or by merchant associated with the transaction.

In some embodiments, the invention further comprises matching the item level data for products of the transaction identified by the received transaction data to financial account data received at the financial institution for processing the transaction.

In some embodiments, presenting feedback for future advertisements based on the request for advertisement correlation data further comprises providing an interactive interface for advertisement searching of generalized item level data to predict future transactions of customers and target advertisements based on the generalized item level data.

In some embodiments, receiving information indicating one or more advertisements for a merchant, product, and/or service viewed by the customer further comprises receiving information identifying that the customer viewed at least one online advertisement by identifying customer selected advertisements, a duration of viewing a webpage with advertisements, scrolling over advertisements during an online session, identifying online search queries, or social network endorsements of the customer.

In some embodiments, matching the merchant, product, and/or service of the one or more advertisements viewed by the customer to transactions completed by the customer further comprises identifying perfect matches and imperfect matches, wherein perfect matches are a same merchant, product, and/or service associated with a transaction of the customer and the at least one advertisement viewed by the customer and imperfect matches are a similar merchant, product, and/or service of a customer transaction and the at least one advertisement viewed by the customer.

In some embodiments, providing advertising effectiveness data including providing a confidence associated with a success of the at least one advertisement based on a likelihood that the at least one advertisement was viewed by the customer, a perfect or imperfect match of products of the at least one advertisement and the transaction, and a time frame between the at least one advertisement for the product and the transaction for the product in a viewed advertisement.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a high level process flow illustrating the customer transaction prompting advertisement presentment advertisement process, in accordance with one embodiment of the present invention;

FIG. 2 provides a process flow illustrating the advertisement impressions and customer transaction correlation process, in accordance with one embodiment of the present invention;

FIG. 3 provides a customer transaction prompting advertisement presentment system environment, in accordance with one embodiment of the present invention;

FIG. 4 provides a process map illustrating identifying item level transaction data, in accordance with one embodiment of the present invention;

FIG. 5 provides a process map illustrating identifying item level transaction data, in accordance with one embodiment of the present invention;

FIG. 6 provides a process map illustrating transaction identification for item level transaction data, in accordance with one embodiment of the present invention;

FIG. 7 provides a process flow illustrating identifying and presenting customer transaction data for advertisement prompting, in accordance with one embodiment of the present invention;

FIG. 8 provides a process flow illustrating matching item level transaction data with viewed advertisement for marketing effectiveness tracking, in accordance with one embodiment of the present invention;

FIG. 9 provides a process map illustrating advertisement impression identification, in accordance with one embodiment of the present invention; and

FIG. 10 provides a process flow illustrating perfect and imperfect matching of item level transaction data with viewed advertisement for marketing effectiveness tracking, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that may are associated with the customer transaction prompting advertisement presentment.

Some portions of this disclosure are written in terms of a financial institution's unique position with respect to customer transactions. As such, a financial institution may be able to utilize its unique position to monitor and identify transactions for products or with merchants that utilize financial institution accounts to complete the transactions.

The embodiments described herein may refer to the initiation and completion of a transaction. Unless specifically limited by the context, a “transaction”, “transaction event” or “point of transaction event” refers to any customer completing or initiating a purchase for a product, service, or the like. The embodiments described herein may refer to an “advertisement.” An advertisement, as used herein may include one or more of a deal, offer, coupon, promotion, incentive, commercial, advertisement, or the like. The advertisement may be for a product, service, merchant, merchant, brand, or the like. Furthermore, the term “product” as used herein may refer to any product, service, good, or the like that may be purchased through a transaction.

Furthermore, the term “electronic receipt” or “e-receipt” as used herein may include any electronic communication between a merchant and a customer, where the communication is associated with a transaction. In this way, e-receipts may include information about the transaction, such as location of purchase, the transaction total, order confirmations, shipping confirmations, item description, SKU data, merchant name, merchant web address, order number, order date, product description, product name, product quantity, product price, product image, hyperlink to the product image on merchant website, sales tax, shipping cost, order total, billing address, shipping company, shipping address, estimated shipping date, estimated delivery date, tracking number, and the like.

The embodiments described herein may refer to the use of a transaction, transaction event or point of transaction event to trigger the steps, functions, routines, or the like described herein. In various embodiments, occurrence of a transaction triggers the sending of information such as offers and the like. Unless specifically limited by the context, a “transaction”, “transaction event” or “point of transaction event” refers to any communication between the customer and the merchant, e.g. financial institution, or other entity monitoring the customer's activities. In some embodiments, for example, a transaction may refer to a purchase of goods or services, a return of goods or services, a payment transaction, a credit transaction, or other interaction involving a customer's bank account. As used herein, a “bank account” refers to a credit account, a debit/deposit account, or the like. Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, opening a bank application on a customer's computer or mobile device, a customer accessing their e-wallet or any other interaction involving the customer and/or the customer's device that is detectable by the financial institution. As further examples, a transaction may occur when an entity associated with the customer is alerted via the transaction of the customer's location. A transaction may occur when a customer accesses a building, uses a rewards card, and/or performs an account balance query. A transaction may occur as a customer's mobile device establishes a wireless connection, such as a Wi-Fi connection, with a point-of-sale (or point-of-transaction) terminal. In some embodiments, a transaction may include one or more of the following: purchasing, renting, selling, and/or leasing goods and/or services (e.g., groceries, stamps, tickets, DVDs, vending machine items, and the like); withdrawing cash; making payments to creditors (e.g., paying monthly bills; paying federal, state, and/or local taxes and/or bills; or the like); sending remittances; transferring balances from one account to another account; loading money onto stored value cards (SVCs) and/or prepaid cards; donating to charities; and/or the like.

In some embodiments, the transaction may refer to an event and/or action or group of actions facilitated or performed by a customer's device, such as a customer's mobile device. Such a device may be referred to herein as a “point-of-transaction device”. A “point-of-transaction” could refer to any location, virtual location or otherwise proximate occurrence of a transaction. A “point-of-transaction device” may refer to any device used to perform a transaction, either from the customer's perspective, the merchant's perspective or both. In some embodiments, the point-of-transaction device refers only to a customer's device, in other embodiments it refers only to a merchant device, and in yet other embodiments, it refers to both a customer device and a merchant device interacting to perform a transaction. For example, in one embodiment, the point-of-transaction device refers to the customer's mobile device configured to communicate with a merchant's point of sale terminal, whereas in other embodiments, the point-of-transaction device refers to the merchant's point of sale terminal configured to communicate with a customer's mobile device, and in yet other embodiments, the point-of-transaction device refers to both the customer's mobile device and the merchant's point of sale terminal configured to communicate with each other to carry out a transaction.

In some embodiments, a point-of-transaction device is or includes an interactive computer terminal that is configured to initiate, perform, complete, and/or facilitate one or more transactions. A point-of-transaction device could be or include any device that a customer may use to perform a transaction with an entity, such as, but not limited to, an ATM, a loyalty device such as a rewards card, loyalty card or other loyalty device, a magnetic-based payment device (e.g., a credit card, debit card, or the like), a personal identification number (PIN) payment device, a contactless payment device (e.g., a key fob), a radio frequency identification device (RFID) and the like, a computer, (e.g., a personal computer, tablet computer, desktop computer, server, laptop, or the like), a mobile device (e.g., a smartphone, cellular phone, personal digital assistant (PDA) device, MP3 device, personal GPS device, or the like), a merchant terminal, a self-service machine (e.g., vending machine, self-checkout machine, or the like), a public and/or business kiosk (e.g., an Internet kiosk, ticketing kiosk, bill pay kiosk, or the like), a gaming device, and/or various combinations of the foregoing.

In some embodiments, a point-of-transaction device is operated in a public place (e.g., on a street corner, at the doorstep of a private residence, in an open market, at a public rest stop, or the like). In other embodiments, the point-of-transaction device is additionally or alternatively operated in a place of business (e.g., in a retail store, post office, banking center, grocery store, factory floor, or the like). In accordance with some embodiments, the point-of-transaction device is not owned by the customer of the point-of-transaction device. Rather, in some embodiments, the point-of-transaction device is owned by a mobile business operator or a point-of-transaction operator (e.g., merchant, vendor, salesperson, or the like). In yet other embodiments, the point-of-transaction device is owned by the financial institution offering the point-of-transaction device providing functionality in accordance with embodiments of the invention described herein.

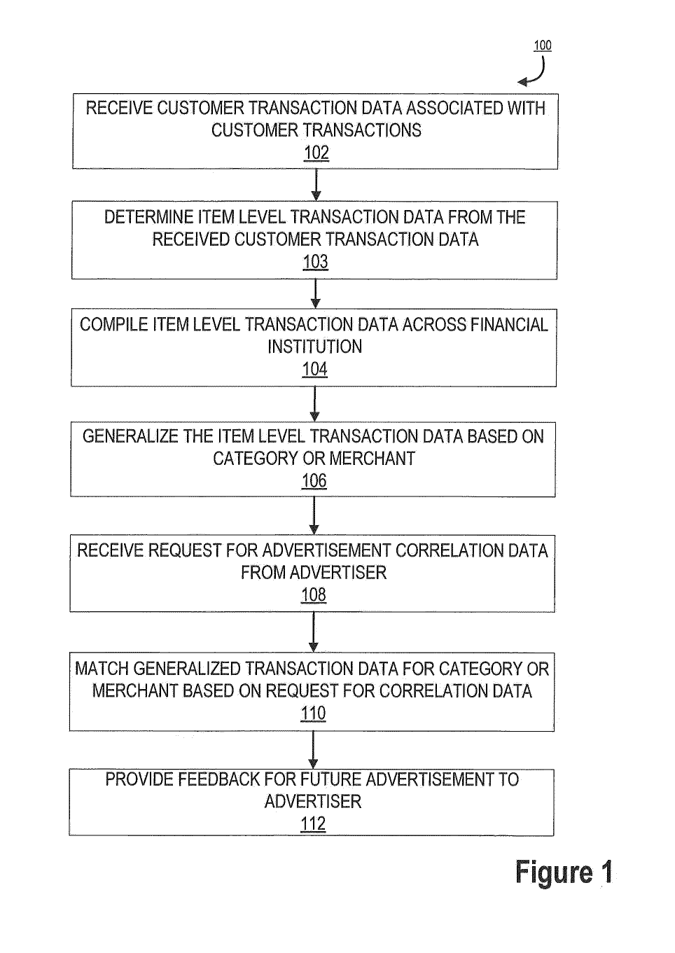

FIG. 1 provides a high level process flow illustrating the customer transaction prompting advertisement presentment advertisement process 100, in accordance with one embodiment of the present invention. As illustrated in block 102, the process is initiated when the system receives customer transaction data associated with customer transactions. In some embodiments, the customer transaction data may be received from a customer. In some embodiments, the customer transaction data may be received from a merchant. In yet other embodiments, the financial institution associated with the system may retrieve the customer transaction data based on the customer using a financial institution account for the transaction.

Next, as illustrated in block 103, the process 100 continues by determining the item level transaction data from the received customer transaction data. The received customer transaction data may include data from electronic communications between a customer and a merchant, such as an electronic receipt, order, invoice, of the like. In some embodiments, the received customer transaction data may include SKU or code data associated with the products of the transaction. Based on the electronic communications and/or the SKU data, the system may determine the item level transaction data associated with the transaction. The item level transaction data may include any data associated with the specific products or services of the transaction. In this way, the make, model, type, category, merchant, price, and the like are identified with the product and/or service of the transaction.

As illustrated in block 104, next the process 100 continues by compiling the item level transaction data across the financial institution. In this way, the system may track and compile all of the item level transaction data that may be identified across the financial institution from the various accounts associated therewith.

Once the item level transaction data is compiled across the financial institution, the item level transaction data is generalized based on category or merchant of the transaction, as illustrated in block 106. In this way, the system may generalize the item level transaction data compiled within the financial institution. As such, general numbers, statistical data, or data may be generated based on the item level transaction data into category of product and/or by merchant.

As illustrated in block 108, the system may receive a request for advertisement correlation data from an advertiser. In this way, the advertiser may request data for a product, a location, a merchant, a demographic, or the like. The advertisement correlation data may include the generalized item level transaction data. As such, the data may include information about transactions that the customer has already completed. In this way, the request is for data for future advertisements for a product or merchant to identify a target audience, such as a demographic, an individual, a location, a location, or type of person purchasing the product or from the merchant.

Furthermore, the request may be from a merchant requesting information for other brands or merchants. In this way, the merchant can identify what products customers are purchasing at that merchant compared to other merchants. This identifying products or brands that may be of interest to the merchant to stock in the future. Furthermore, the merchant could identify pricing issues based on this requested data. In this way, the system may be able to generate generic pricing data for the item of the item level data. This pricing may be generalized and provided to the merchant as requested data. This way, the merchant may identify one or more products that the merchant has mispriced relative to the competition. In yet other embodiments, the request could identify SKU competition, such as if a merchant has an exclusive deal with a brand or manufacturer. The generalized transaction data of the correlation data presented may provide the merchant with insight as to whether an exclusive deal improves the merchant's market position or not.

Next, based on the request, the process 100 may continue by matching the generalized transaction data for a category or merchant, as illustrated in block 110. In this way, the system matches the item level data to the requested data by the advertiser. Finally, as illustrated in block 112, the process 100 continues by providing feedback for future advertisements to the advertiser based on the request. The feedback may be in the form of marketing effectiveness data to one or more advertisers or merchants. The feedback provides customer advertisement impressions and customer transaction correlations for advertisement effectiveness.

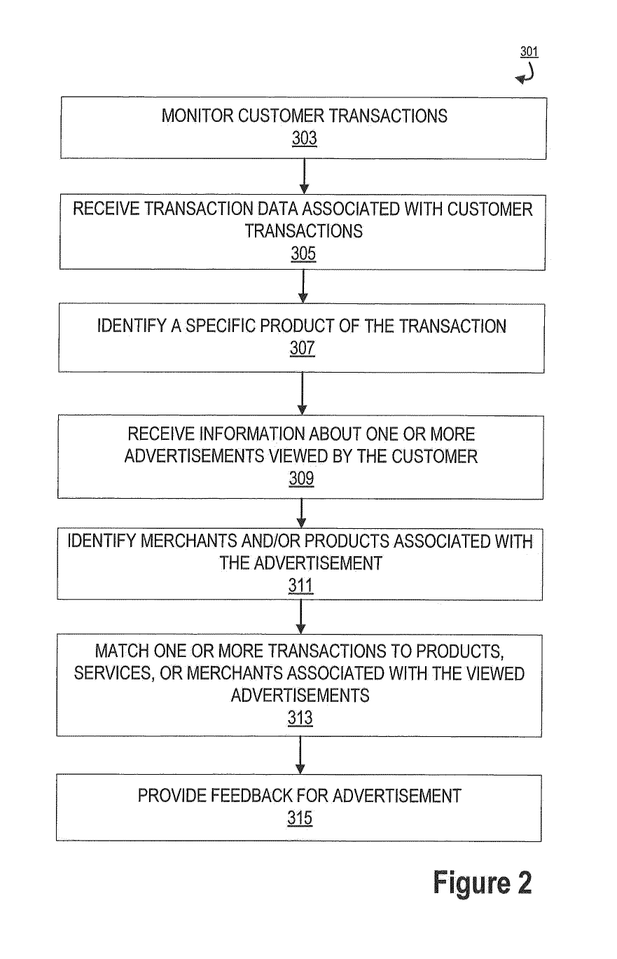

FIG. 2 provides a process flow illustrating the advertisement impressions and customer transaction correlation process 301, in accordance with one embodiment of the present invention. First, as illustrated in block 303, the process is initiated by monitoring customer transactions. The system is able to do this based on the financial institution being involved in the transaction, such as being the manager of the account used by the customer for the transaction, being the financial institution managing the account of the merchant, or the like.

Next, as illustrated in block 305, the process 301 continues to receive transaction data associated with the customer transactions. In some embodiments, the system may receive transaction data from a merchant. In some embodiments, the system may receive transaction data from a customer. In yet other embodiments, the system may monitor and retrieve transaction data associated with a customer transaction based on the financial institution being involved in the transaction.

Based on the received transaction data, the specific products of the transaction may be identified, as illustrated in block 307. The specific products of the transaction may be identified based on receiving item level product information from an electronic communication between the merchant and the customer. These communications may include one or more electronic receipts, invoices, orders, or the like sent electronically. In some embodiments, the specific products of the transaction may be identified based on stock keeping unit (SKU) identification of the products associated with the transaction. The specific products of the transaction, specifically item level data, may be identified based on electronic communications between the merchant and customer and/or SKU identification. In some embodiments, the system may be provided with this data from a financial institution. In other embodiments, the system may determine the data based on the system being implemented by a financial institution. In some embodiments, the system may determine the data by receiving or retrieving information from the merchant, social networks, and/or the customer.

Next, as illustrated in block 309, the process 301 continues when the system receives an indication that one or more customers viewed an advertisement. In this way, the system may receive, from a merchant, advertiser, or the like, an indication that customers viewed an advertisement.

An advertiser or merchant may provide information to the system regarding the advertisements that were viewed by a customer, such as a customer identification, merchant, time period, geographic location, transaction channel, or the like associated with the advertisement.

In some embodiments, the advertisement viewed by the customer may be online. In other embodiments, the advertisement viewed by the customer may offline, such as in printed version, such as in a newspaper, magazine, billboard, or the like. For online advertisements, customer views of the website or advertisements that the customer is predicted to have viewed via a website are identified. In this way, the customer may be on one or more webpages on the internet. The customer may be presented with multiple advertisements, such as offers, deals, promotions, incentives, or the like while accessing the internet. The system may receive an indication that the customer viewed or potentially viewed the advertisements. As such, the system may retrieve, and/or receive customer advertisement impressions, which are advertisements that a customer viewed. The viewed advertisements may be identified by the customer selecting or clicking an advertisement, by scrolling over the advertisement, a duration of viewing the advertisement, customer searches and search results, social network endorsements, or the like.

For offline advertisements, one or more advertisements may be viewed or predicted to have been viewed by the customer offline. These advertisements may include billboards, magazines, newspapers, flyers, television, or the like. The customer may be presented with multiple advertisements, such as offers, deals, promotions, incentives, or the like while offline. The system may receive information associated with the advertisements viewed or potentially viewed by the customer. As such, the system receives and/or identifies customer advertisement impressions or advertisements viewed by the customer. The viewed advertisements may be identified by customer newspaper or magazine subscriptions, global positioning systems (GPS), travel routes, travel or transportation location purchases, television guides, or the like.

The system may then identify the merchants and/or products associated with the advertisement, as illustrated in block 311. In some embodiments, once the system receives the advertisements viewed by the customer, the merchant, product, service, offer, promotion, or the like associated with the advertisement is identified. In some embodiments, this information may be received from the advertiser or merchant. In other embodiments, the system may retrieve the information about the merchant or product based on knowledge of advertisement viewed by the customer, advertisement positioning, object recognition, or the like.

Once item level transaction data and customer viewed advertisements are identified, the system may match one or more transactions to products, services, or merchants associated with the viewed advertisements, as illustrated in block 313. As such, a match may identify one or more products or services purchased by the customer where the customer viewed an advertisement for that product prior to purchasing the product. In this way, indicating a positive advertisement or marketing campaign. In this way, the system may determine an advertisement interest in a category of a product, a product, or the like.

Finally, as illustrated in block 315, feedback may be provided for the advertisement effectiveness. As such, the invention generates marketing effectiveness data that tracks the advertisements and the effectiveness of the advertisements based on purchases associated with advertisement impressions and aids in predicting future marketing strategy and advertisement focusing. Along with this, the system bridges an important advertising gap between an advertisement and a subsequent brink and mortar store purchase.

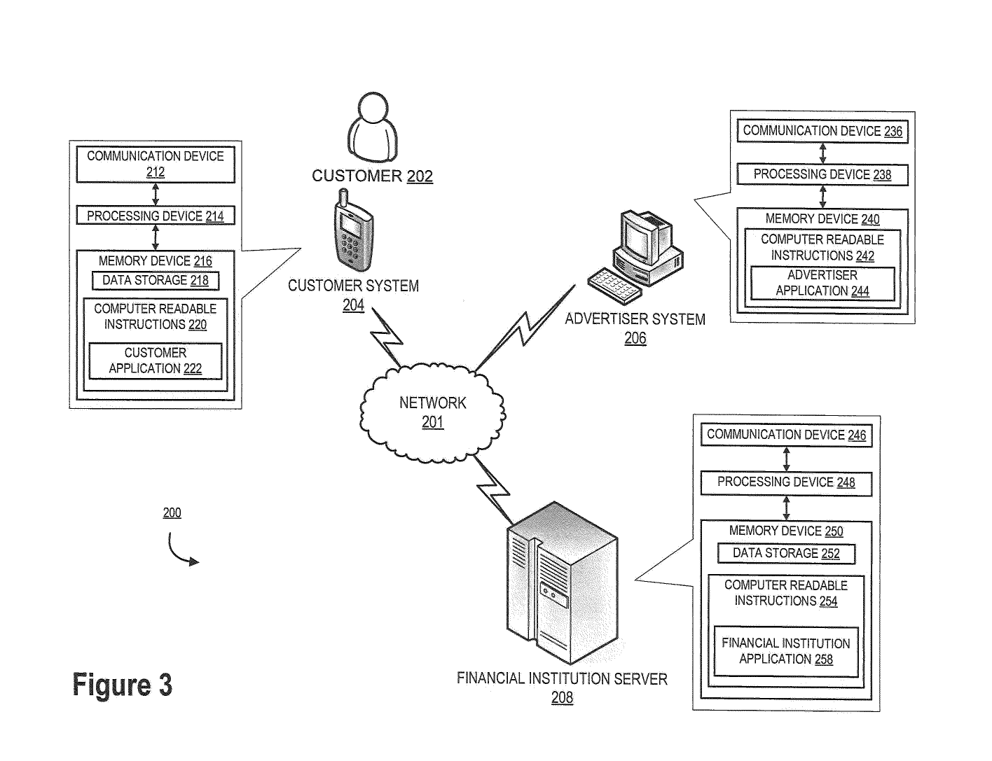

FIG. 3 illustrates a customer transaction prompting advertisement presentment system environment 200, in accordance with one embodiment of the present invention. As illustrated in FIG. 3, the financial institution server 208 is operatively coupled, via a network 201 to the customer system 204, and to the advertiser system 206. In this way, the financial institution server 208 can send information to and receive information from the customer system 204 and the advertiser system 206 to provide customer transaction prompting advertisement presentment and impressions data. FIG. 3 illustrates only one example of an embodiment of a customer transaction prompting advertisement presentment system environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the customer 202 is an individual viewing an advertisement online or offline. The customer 202 may subsequently make one or more transactions to purchase a product. In some embodiments, the purchase may be made by the customer 202 using a customer system 204. In some embodiments, the customer 202 may be a merchant or a person, employee, agent, associate, independent contractor, and the like that has an account or business with a financial institution or another financial institution that may provide payment to complete a transaction.

FIG. 3 also illustrates a customer system 204. The customer system 204 generally comprises a communication device 212, a processing device 214, and a memory device 216. The customer system 204 is a computing system that allows a customer 202 to interact with the financial institution to set up payment or transaction accounts to complete transactions for products and/or services. The processing device 214 is operatively coupled to the communication device 212 and the memory device 216. The processing device 214 uses the communication device 212 to communicate with the network 201 and other devices on the network 201, such as, but not limited to the advertiser system 206 and the financial institution server 208. As such, the communication device 212 generally comprises a modem, server, or other device for communicating with other devices on the network 201.

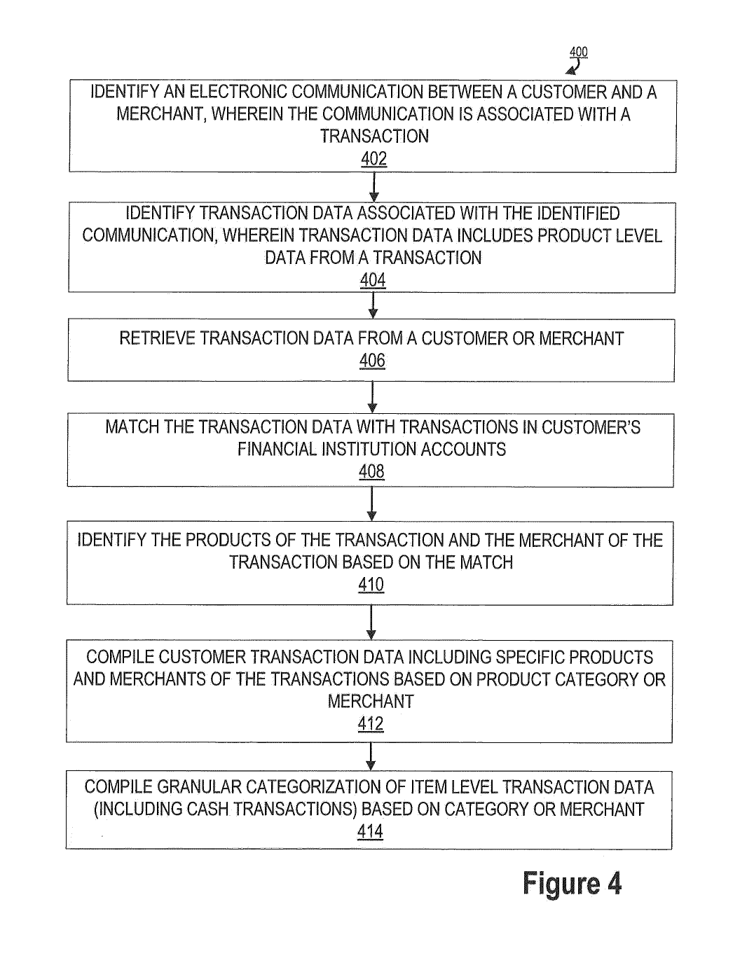

The customer system 204 comprises computer-readable instructions 220 and data storage 218 stored in the memory device 216, which in one embodiment includes the computer-readable instructions 220 of a customer application 222. In this way, a customer 202 may open a financial institution account, remotely communicate with the financial institution, authorize and complete a transaction, or complete a transaction using the customer's customer system 204. The customer system 204 may be, for example, a desktop personal computer, a mobile system, such as a cellular phone, smart phone, personal data assistant (PDA), laptop, or the like. Although only a single customer system 204 is depicted in FIG. 4, system environment 200 may contain numerous customer systems 204.

As further illustrated in FIG. 3, the financial institution server 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the advertiser system 206 and the customer system 204. As such, the communication device 246 generally comprises a modem, server, or other device for communicating with other devices on the network 201.

As further illustrated in FIG. 3, the financial institution server 208 comprises computer-readable instructions 254 stored in the memory device 250, which in one embodiment includes the computer-readable instructions 254 of a financial institution application 258. In some embodiments, the memory device 250 includes data storage 252 for storing data related to the customer transaction prompting advertisement presentment system environment, but not limited to data created and/or used by the financial institution application 258.

In the embodiment illustrated in FIG. 3 and described throughout much of this specification, the financial institution application 258 may receive customer transaction data, determine item level transaction data from the received customer transaction data, generalize the item level transaction data across the financial institution, receive requests for advertisement correlation data, matched generalized transaction data to the request, and provide feedback based on the request.

In some embodiments, the financial institution application 258 may receive customer transaction data. The customer transaction data may identify one or more financial transactions of the customer 202 for products, merchants, or services associated with a merchant. The customer transaction data may be identified based on electronic communications between the merchant and customer and/or stock keeping unit (SKU) identification. In some embodiments, the financial institution application 258 may be provided with the customer transaction data from a financial institution. In some embodiments, the financial institution application 258 may determine customer transaction data by receiving or retrieving information from the merchant, social networks, and/or the customer.

Customer transaction data may be received in the form of SKU level data and/or data from electronic communications between the customer and merchant. SKU level data may be received via the network 201. SKU level data may include specific information about a product purchased by a customer during a customer transaction. This may include codes or the like that identify the specific products of the transaction. The electronic communications data may include one or more of an electronic receipt, invoice, payment, order, report, or other communication identifying a transaction between the customer and merchant.

In some embodiments, the financial institution application 258 may determine item level transaction data from the received customer transaction data. As such, the financial institution application 258 may determine item level data from the received SKU level data and the received electronic communications data. Item level data identifies the specific item associated with the received SKU level data or the received electronic communications data. In this way, the specific item, price, model number, merchant, manufacturer, brand, or the like may be identified.

In some embodiments, the financial institution application 258 may generalize the item level transaction data across the financial institution. In this way, the financial institution application 258 may compile the item level transaction data across the financial institution. As such, item level transaction data may be compiled together and grouped based on a category of product, merchant, or by specific product. Subsequently, the data compiled is generalized within the financial institution by the financial institution application 258. As such, the generalized information includes information about a number of customers that purchased a product, a category of products, or from a merchant within a given time period. The generalized information does not include information about the customer 202 making a purchase, but instead general numbers associated with the number of customers that purchased a product, a category of products, or from a merchant within a given time period.

In some embodiments, the financial institution application 258 may receive requests for advertisement correlation data. As such, the financial institution application 258 may receive a request from an advertiser or the like via the network 201, the request being for the generalized item level transaction data. The request may be for a specific merchant, product, time period, geographic location, or the like. In this way, the advertiser may request data to better target customers in future advertisements. The request may be for generalized item level transaction data in the form of graphs, charts, or the like that depict the purchases associated with that request. As such, the advertiser may have a better indication as to the demographic of individuals purchasing products from brink and mortar locations.

In some embodiments, the financial institution application 258 may match the generalized transaction data to the request received. In this way, the financial institution application 258 may generate advertisement correlation data based on the request from the advertiser. The advertisement correlation data is filtered and matched to the generalized item level transaction data based on an advertisers request for data for a specific merchant, product, category of products, geographic location, or the like.

In some embodiments, the financial institution application 258 may provide feedback based on the request. The feedback is presented as generalized advertisement correlation data to the advertiser for future advertisements. This data may be presented from the financial institution application 258 via the network 201 to the advertiser system 206. The advertisement correlation data may be presented via an interface or the like in an interactive format such that the advertiser may further search or identify the data required for future advertisement feedback the advertiser desires.

Furthermore, in some embodiments, the financial institution application 258 may receive indications that the customer viewed an advertisement, receive information about the merchants and products associated with the viewed advertisements, receive customer transaction data associated with customer 202 transactions, find and match at least one monitored transactions to products or merchants associated with the advertisements viewed, and prepare to present advertisement effectiveness data.

In some embodiments, in conjunction with the advertiser system 206, the financial institution application 258 may receive an indication that a customer 202 viewed an advertisement. Furthermore this indication of customer viewing may also include a time and date that the customer 202 viewed the advertisement. In some embodiments, multiple dates and times may be identified if the customer 202 has viewed the advertisement at multiple times. In yet other embodiments, a duration or time frame may be identified if the customer 202 has been identified as viewing the advertisement for any duration of time. In some embodiments, the advertisement may be online. In other embodiments, the advertisement may be offline. For online advertisements, the financial institution application 258 may identify advertisement impressions when a customer 202 views or is predicted to have viewed the advertisement via the internet. In this way, the customer 202 may be on one or more webpages on the internet. The customer 202 may be presented with multiple advertisements, such as offers, deals, promotions, incentives, or the like while accessing the internet. The financial institution application 258 may identify the advertisements viewed or potentially viewed by the customer 202. The viewed advertisements may be identified by the financial institution application 258 based on an identification of factors, including, but not limited customer 202 selecting or clicking an advertisement, customer 202 scrolling over the advertisement, a determined duration the customer 202 viewed the advertisement, customer 202 searches and search results, social network endorsements of the customer 202, or the like.

In some embodiments, in conjunction with the advertiser system 206, the financial institution application 258 may receive information about the merchants and products associated with the viewed advertisements. The merchant or product may be identified based on knowledge of advertisement positioning from communications with the advertiser system 206 via the network 201, object recognition, or the like. In some embodiments, the customer 202 that is viewing the advertisement may also be identified and that information may be received by the financial institution application 258. The customer 202 may be identified based on internet protocol address, log-in information for the customer 202, global positioning systems, mobile communication links, wireless networks, or the like.

In some embodiments, the financial institution application 258 may receive customer transaction data associated with customer 202 transactions. The financial institution application 258 may identify customer 202 transactions for specific transactions associated with products or merchants of the advertisement viewed by the customer 202. Furthermore, the customer transaction data may include a payment type used for the transaction and a time stamp for the transaction. The payment type may be a credit card, debit card, cash, gift card, check, or the like.

In some embodiments, the financial institution application 258 may find and match at least one monitored transactions to products or merchants associated with the advertisements viewed. In this way, matching the merchant, product, and/or service of the one or more advertisements viewed by the customer 202 to transactions completed by the customer 202 comprises identifying a date and/or a date and time of a transaction completed by the customer 202 and matching it with an advertisement viewed by the customer 202, if the date and/or date and time of the transaction is after the date and time when the customer 202 viewed the advertisement.

In some embodiments, matching the merchant, product, and/or service of the one or more advertisements viewed by the customer 202 to transactions completed by the customer comprises identifying perfect matches and imperfect matches, wherein perfect matches are a same merchant, product, and/or service associated with a transaction of the customer 202 and the at least one advertisement viewed by the customer 202 and imperfect matches are a similar merchant, product, and/or service of a customer transaction and the at least one advertisement viewed by the customer 202.

Finally, the financial institution application 258 may compile advertisement effectiveness data and provide it to the advertisers via the advertiser system 206 for marketing analysis and effectiveness tracking.

As illustrated in FIG. 3, the advertiser system 206 is connected to the financial institution server 208 and is associated with the entity providing the advertisements. In this way, while only one advertiser system 206 is illustrated in FIG. 3, it is understood that multiple advertiser systems may make up the system environment 200. The advertiser system 206 generally comprises a communication device 236, a processing device 238, and a memory device 240. The advertiser system 206 comprises computer-readable instructions 242 stored in the memory device 240, which in one embodiment includes the computer-readable instructions 242 of an advertiser application 244.

In the embodiment illustrated in FIG. 3, the advertiser application 244 provides advertisements to customers 202, identifies customers 202 that viewed the advertisement, identifies merchants and products of the advertisements, presents requests for advertisement correlation data, and receives feedback for both marketing effectiveness and future advertisement data in the form of advertisement correlation data.

In some embodiments, the advertiser application 244 may provide the advertisements to the customers 202. The advertiser application 244 may present advertisements via online means or offline means based on the targeted audience the advertiser wishes to target. In some embodiments, the advertiser application 244 may operate in conjunction with the financial institution application 258 to determine that a customer 202 viewed an advertisement and the identification of the customer 202 who viewed the advertisement. In this way, the advertiser application 244 may have data associated with subscriptions provided to customers 202, locations of advertisements, and the like that aid the system determining if a customer 202 viewed an advertisement and/or the identification of the customer 202 viewing the advertisement.

In some embodiments, the advertiser application 244, in conjunction with the financial institution application 258, may identify merchants and products of the advertisements. In this way, the advertiser application 244 is associated with the advertiser. In this way, the advertiser application 244 may have information associated with the products of the advertisement and/or the merchants associated with the advertisement. In some embodiments, the advertiser application 244 may be associated with the merchant of the advertisement.

In some embodiments, the advertiser application 244 may request for advertisement correlation data from the financial institution application 258. In this way the advertiser application 244 may communicate with the financial institution application 258 via the network 201 to request advertisement correlation data. Advertisement correlation data may comprise generalized customer data about item level purchases categorized by product or merchant. In some embodiments, the request for advertisement correlation data may be for a specific geographic region, demographic, product, merchant, or the like. In this way, the advertiser may request data to better target customers in future advertisements based on categorized item level transaction data for customer purchases. The request may be for generalized item level transaction data in the form of graphs, charts, or the like that depict the purchases associated with that request. As such, the advertiser application 244 may provide advertisements to the customer 202 based on the received advertisement correlation data.

Finally, the system may provide feedback to the advertiser for future advertisements in the form of advertisement correlation data or feedback to the advertiser in the form of advertisement effectiveness data. In some embodiments, the advertiser application 244 may receive feedback from the financial institution server 208.

The advertiser application 244 may receive feedback communication via the network 201 from the financial institution application 258. The feedback may be advertisement correlation data. This data may be generalized item level transaction data based on category and request of the advertiser. This data may be provided in graph, chart, or other form on an interactive interface, such that the advertiser may request or search of data within other fields to be provided with advertisement correlation data relevant to the advertiser future advertisements.

The advertiser application 244 may receive feedback communication via the network 201 from the financial institution application 258. In some embodiments, the feedback maybe based on the results of the advertisement impressions and customer 202 transaction correlations. In this way, the advertiser may receive feedback for advertisements already presented to the customer 202. In this way, the financial institution server 208 may generate marketing effectiveness data that tracks the advertisements and the effectiveness of the advertisements based on purchases made by a customer 202 after the customer has viewed an advertisement associated with the product or merchant. In this way, the advertisement effectiveness data may aid in predicting future marketing strategy and advertisement focusing. Along with this, the system bridges an important advertising gap between an advertisement and a subsequent brink and mortar store purchase.

It is understood that the servers, systems, and devices described herein illustrate one embodiment of the invention. It is further understood that one or more of the servers, systems, and devices can be combined in other embodiments and still function in the same or similar way as the embodiments described herein.

FIG. 4 illustrates a process map for identifying item level transaction data 400, in accordance with one embodiment of the present invention. As illustrated in block 402, the process 400 is initiated by identifying one or more electronic communications between a customer and a merchant. The electronic communications identified are e-receipts or the like associated with a transaction between the customer and the merchant to identify item level transaction data, such as the product and merchant of the transaction. In some embodiments, in order to identify the electronic communications the system may have access to the customer's email account or other account in which the communication is sent. In this way, the system may continue to monitor the customer's accounts in order to identify electronic communications between a merchant and customer related to a transaction.

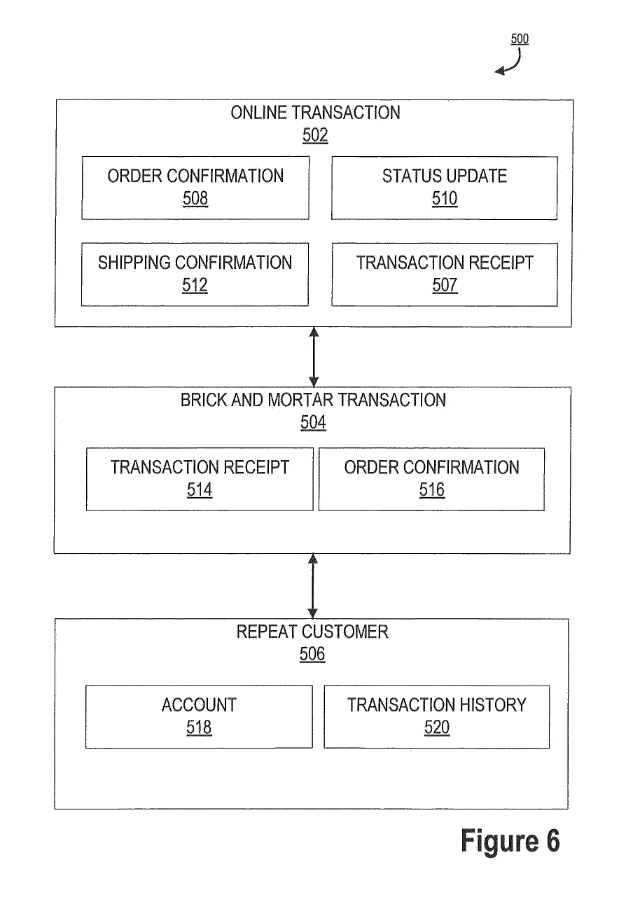

FIG. 6 illustrates a process map of transaction identification for item level transaction data 500, in accordance with one embodiment of the present invention. The potential electronic communications include communications that derived from online transactions 502, brick and mortar transactions 504, or repeat customer 506 transactions.

In some embodiments, online transaction 502 communications may include transaction receipts 507. Other communications for online transactions 502 may include order confirmations 508, status updates 510, shipping updates 512, or the like. The combination of all of these communications may be considered e-receipts. E-receipts may be any electronic communication from a merchant to a customer based on a transaction. An order confirmation 508 may include detailed information regarding the products or services purchased. For example, in the case of a product, the order confirmation may include stock keeping unit “SKU” code level data, as well as other parameters, such as order number, order date, product description, product name, product quantity, product price, product image, hyperlink to the product image on merchant website, sales tax, shipping cost, order total, billing address, shipping company, shipping address, estimated shipping date, estimated delivery date, tracking number, and the like. The order confirmation 508 also includes information about the merchant, such as name, address, phone number, web address, and the like. The shipment confirmation 512 may be an email, text, voice, or other correspondence from a merchant to a customer indicating the shipment of a product from an online transaction. Status updates 510 may include any type of communication from a merchant that may update the shipping, delivery, order, or stocking of a product of a transaction.

In some embodiments, purchase transaction communications may include communications related to transactions at a brick and mortar location 504. In this way, many merchants now also provide e-receipts and other electronic communications to customers shopping at brick and mortar locations. In some embodiments, these communications may include transaction receipts 514, such as an e-receipt. In other embodiments, these communications may include order confirmations 516. In general, at the point of sale, the customer may have previously configured or may be asked at the time of sale as to whether she wishes to receive an e-receipt. By selecting this option, the merchant will send an electronic communication in the form of an e-receipt to the customer's designated email address.

Here again, the e-receipt will typically include a list of services and/or products purchased with SKU level data, and other parameters, as well as information about the merchant, such as name, address, phone number, store number, web address, and the like.

In some embodiments, purchase transaction communications may include communications from a repeat customer account 506. Various merchants now also provide online customer accounts 518 for repeat customers. These online customer accounts 518 may include purchase history 520 information associated with the customer accessible by the customer via ID and passcode entry. Purchase history provides detailed information about services and products purchased by the customer including information found on order confirmations and shipping confirmations for each purchase. Online customer accounts are not limited to online purchases. Many merchants also provide online customer accounts for customers that purchase services and products at brick and mortar locations and then store these transactions in the customer's online account.

Referring back to FIG. 4, as illustrated in block 404, the system may identify item level transaction data associated with the identified communication. This item level transaction data includes product purchase level data from a transaction between the merchant and customer.

As illustrated in block 406, the system may extract the item level transaction data identified. This extraction may be from a customer account, such as an email account or the like. In other embodiments, the extraction may be from a text, voice, or the like message communicated to the customer.

Regarding email extraction, the system may initially gain access to the customer's email accounts and retrieves email message headers comprising data fields relative to the email message, such as sender, subject, date/time sent, recipient, and the like. In some embodiments, the system accesses the emails directly. In other embodiments, the system may run search queries of the email database based on known merchant names and/or phrases associated with e-receipt information, such as “receipt,” “order confirmation,” “shipping confirmation,” or the like. Once emails are extracted, further filtering may occur to locate relevant emails. Examples of further filtering may be searches based on known online merchants, third parties known to provide e-receipts, text in the email message subject line that corresponds to known order confirmation subject line text or known shipping confirmation subject line text, such as an email message sent with a subject line containing the text “purchase,” “order,” “ordered,” “shipment,” “shipping,” “shipped,” “invoice,” “confirmed,” “confirmation,” “notification,” “receipt,” “e-receipt,” “e-receipt,” “return,” “pre-order,” “pre-ordered,” “tracking,” “on its way,” “received,” “fulfilled,” “package,” and the like.

In some embodiments, the system may convert the identified item level transaction data from the communication into a structured format for the online banking application to utilize the transaction data extracted.

Financial institutions currently use a data structure conforming to Open Financial Exchange “OFX” specifications for the electronic exchange of financial data between financial institutions, businesses and customers via the Internet. E-receipts, such as electronic order confirmations, shipment confirmation, receipts, and the like typically do not comply to a uniform structure and are generally considered to include data in an “unstructured” format. For example, while one merchant may provide data in an electronic communication to a customer in one format, another merchant may use a completely different format. One merchant may include merchant data at the top of a receipt and another merchant may include such data at the bottom of a receipt. One merchant may list the purchase price for an item on the same line as the description of the item and list the SKU number on the next line, while another merchant may list the data in a completely opposite order. As such, prior to integration of electronic communications relating to customer purchases into online banking, the data from such electronic communications must be parsed into a structured form.

Next, as illustrated in block 408, the process 400 continues by matching the item level transaction data identified from the electronic communication between a customer and merchant with a corresponding transaction identified from a customer's financial institution account. As such, electronic communication data received may be matched to a transaction identified at the financial institution. As illustrated in block 410, the process 400 continues by identifying the products of the transaction and the merchants associated with the transaction based on the match the transaction data identified from the electronic communication between a customer and merchant with a corresponding transaction identified from a customer's financial institution account.

Next, as illustrated in block 412, the system compiles customer transaction data including specific products and merchants of the transactions, wherein the compiling is based on a grouping by product category or merchant. As such, product or merchant categories may be made and customer transactions that fit those categories may be compiled and stored. Finally, as illustrated in block 414, granulized categorization of item level transaction data may be compiled based on a category or merchant. The item level transaction data includes specific details of products that the customer has purchased based on the identified electronic communication and matched transaction data from the financial institution.

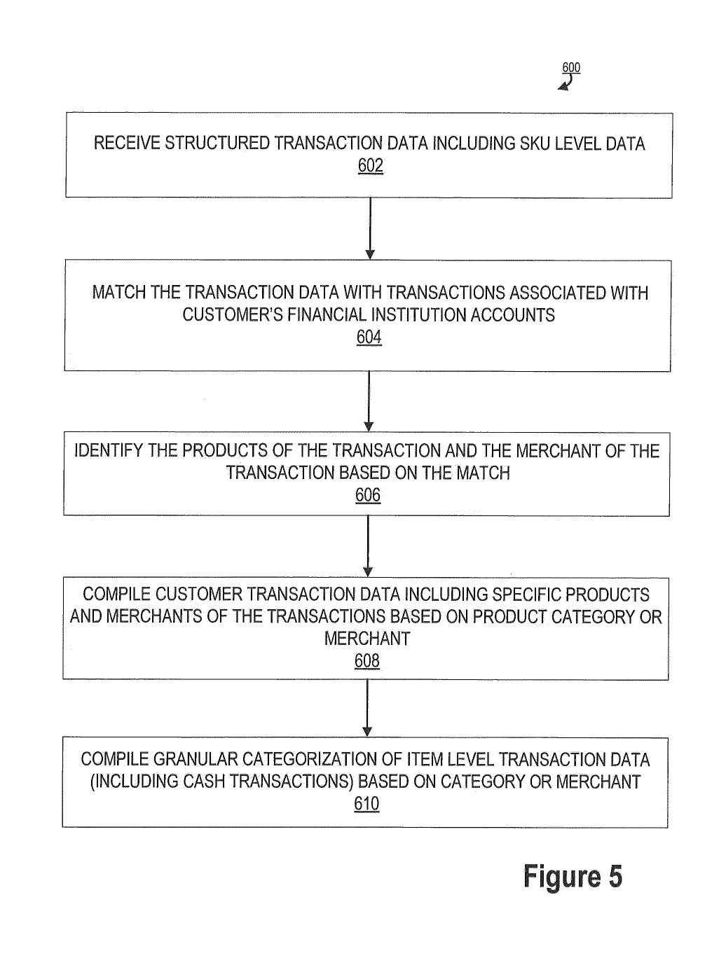

FIG. 5 illustrates a process map for transaction identification for item level transaction data 600, in accordance with one embodiment of the present invention. As illustrated in block 602 the process 600 starts by receiving structured purchase transaction data including SKU level data. In some embodiments, the SKU level data may be received from the customer. In other embodiments, the SKU level data may be received from the merchant. In yet other embodiments, the SKU level data may be identified by the financial institution based on its position in the transaction.

Next, as illustrated in block 604 the process 600 continues to match the SKU item level transaction data with transactions associated with customer's financial institution accounts. In this way, the SKU item level data may be matched to the financial account associated with that product and cross referenced.

As illustrated in block 606, the process 600 continues by identifying the products of the transaction and the merchants associated with the transaction based on the match the item level transaction data identified from the SKU with a corresponding transaction identified from a customer's financial institution account.

Next, as illustrated in block 608, the system compiles customer transaction data including specific products and merchants of the transactions, wherein the compiling is based on a grouping by product category or merchant. As such, product or merchant categories may be made and customer transactions that fit those categories may be compiled and stored. Finally, as illustrated in block 610, granulized categorization of item level transaction data may be compiled based on a category or merchant. The item level transaction data includes specific details of products that the customer has purchased based on the identified electronic communication and matched transaction data from the financial institution.

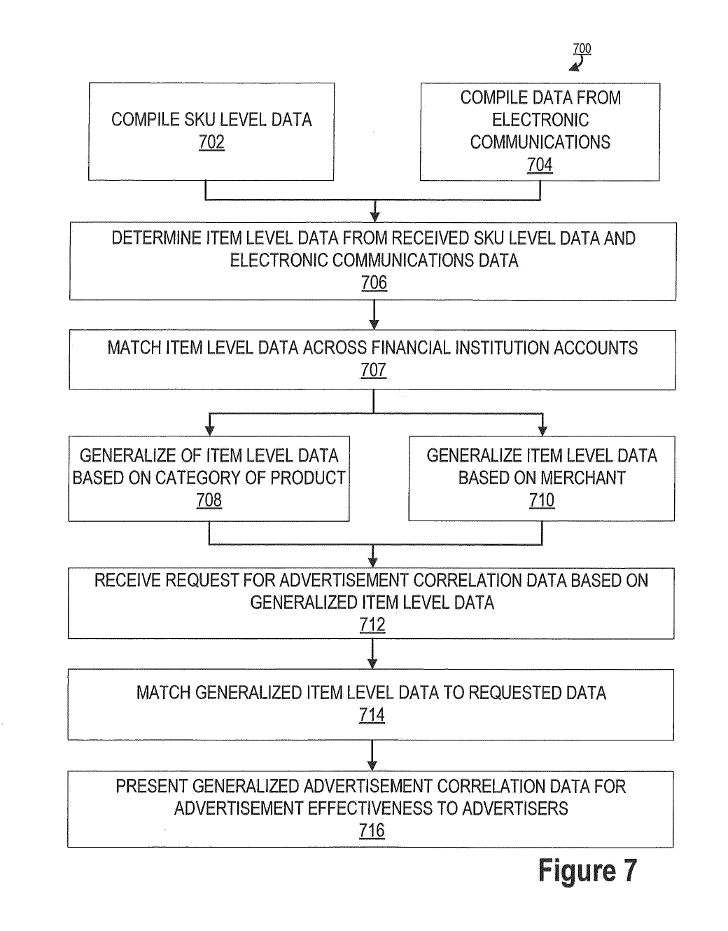

FIG. 7 illustrates a process flow for identifying and presenting customer transaction data for advertisement prompting 700, in accordance with one embodiment of the present invention. As illustrated in block 702, the system compiles SKU level data. In this way, the merchant or customer may provide the system with SKU level data for the products of the transaction. The received SKU level data may be compiled by the system for identification of product level transaction data associated with a customer transaction. As illustrated in block 704, the system may also compile data from electronic communications between a customer and a merchant. The electronic communications data may include one or more of an electronic receipt, invoice, payment, order, report, or other communication identifying a transaction between the customer and merchant.

Next, as illustrated in block 706, the process 700 continues by determining item level data from the received SKU level data and the received electronic communications data from block 702 and 704. Item level data identifies the specific item associated with the received SKU level data or the received electronic communications data. In this way, the specific item, price, model number, merchant, manufacturer, brand, or the like may be identified.

As illustrated in block 707, the system may match and compile the item level transaction data across the financial institution. In some embodiments, the system may also identify item level transaction data from financial institution accounts used by the customer to make a purchase for a product. In this way, multiple locations within the financial institution may have one or more item level data for customers of the financial institution. As such, the item level data is compiled across the financial institution. In some embodiments, the item level data received may be matched to one or more financial institution accounts associated with customers. In this way, the financial institution may match transactions applied to accounts at the financial institution with specific products identified from item level data. In this way, the financial institution may be able to match information received for processing a transaction to item level data for that transaction to be able to have a more complete picture of the transaction, not only the information required for processing the payment, but also item level data associated with that transaction.

As illustrated in block 708 the item level data maybe generalized and grouped based on category of product. As illustrated in block 710, the item level data may be generalized and grouped based on merchant. As such, item level transaction data may be compiled together and grouped based on a category of product, merchant, or by specific product. Subsequently, the data compiled is generalized within the financial institution. As such, the generalized information includes information about a number of customers that purchased a product, a category of products, or from a merchant within a given time period. The generalized information does not include information about the customer making a purchase, but instead general numbers associated with the number of customers that purchased a product, a category of products, or from a merchant within a given time period.

Next, as illustrated in block 712, the system may receive a request from an advertiser or the like for the generalized item level transaction data. The request may be for a specific merchant, product, time period, geographic location, or the like. In this way, the advertiser may request data to better target customers in future advertisements. The request may be for generalized item level transaction data in the form of graphs, charts, or the like that depict the purchases associated with that request. For example, an advertiser may request all purchases made at Merchant A at Time Period B. As such, the system may present information for that time period from that merchant. The information presented may include the various items purchased at Merchant A, the times of purchase within Time Period B, the locations of the purchase, and the like. This way, the advertiser may receive information associated with Merchant A at Time Period B in order to better predict future advertisements during that time period for that merchant.

Furthermore, the request may be from a merchant requesting information for other brands or merchants. In this way, the merchant can identify what products customers are purchasing at that merchant compared to other merchants. This identifying products or brands that may be of interest to the merchant to stock in the future. Furthermore, the merchant could identify pricing issues based on this requested data. In this way, the system may be able to generate generic pricing data for the item of the item level data. This pricing may be generalized and provided to the merchant as requested data. This way, the merchant may identify one or more products that the merchant has mispriced relative to the competition.

Next, as illustrated in block 714, the process 700 continues by matching the item level data across the financial institution to the request from the advertiser. In this way, the system may match the generalized itemized data to the information requested by the advertiser such that the advertiser may receive generalized data associated with the request. The system may generate advertisement correlation data based on the request from the advertiser. The advertisement correlation data filters the generalized item level transaction data based on an advertisers request for data for a specific merchant, product, category of products, geographic location, or the like.

Finally, the system may present generalized advertisement correlation data in the form of feedback to the advertiser for future advertisements, as illustrated in block 716. This data may be presented via an interface or the like in an interactive format such that the advertiser may further search or identify the data required for future advertisement feedback the advertiser desires.

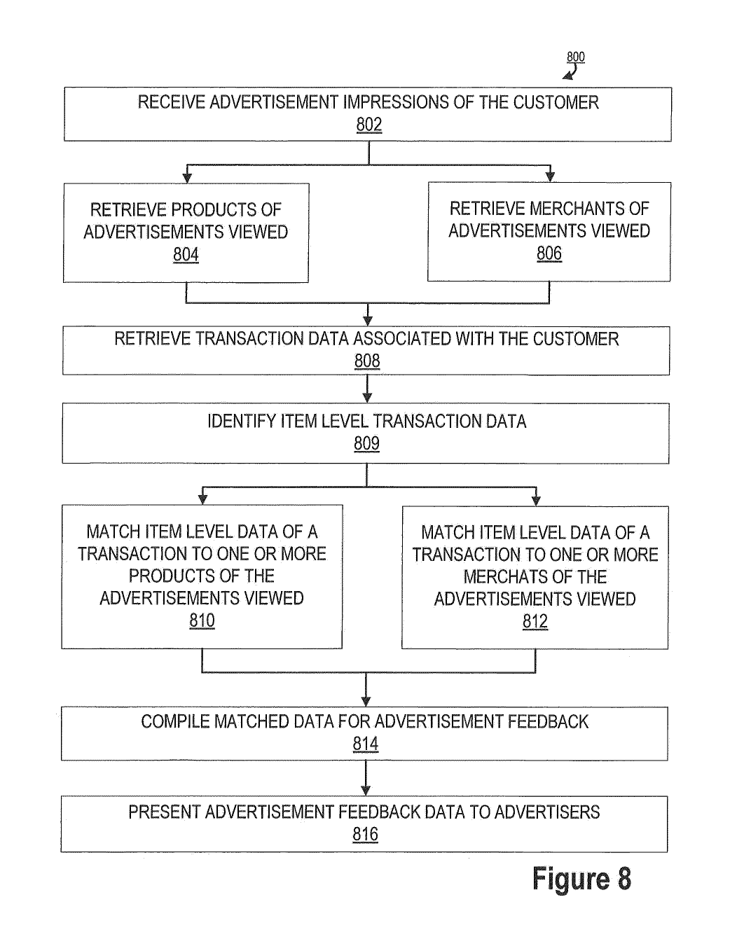

FIG. 8 illustrates a process flow for matching item level transaction data with viewed advertisement for marketing effectiveness tracking 800, in accordance with one embodiment of the present invention. The process 800 is initiated by receiving advertisement impressions of the customer, as illustrated in block 802. Advertisement impressions, as used herein refer to one or more times the customer viewed the advertisement. As such, the system may retrieve information that an advertisement was viewed, but also data about the time and date the advertisement was viewed, the channel of viewing, the duration of viewing the advertisement, and/or the number of times a customer viewed the advertisement.

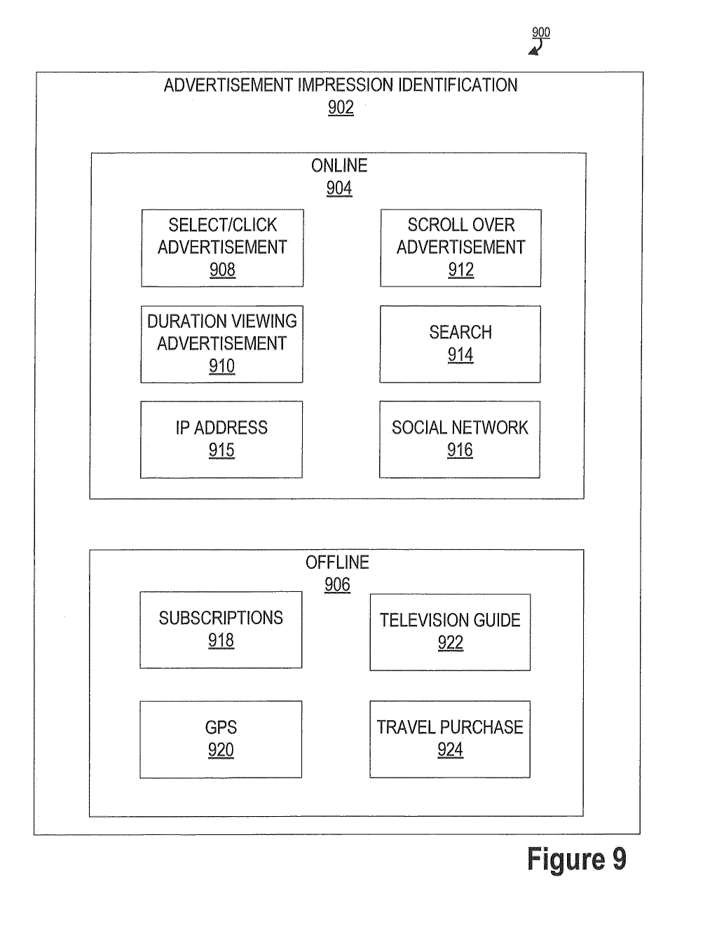

FIG. 9 illustrates a process map of advertisement impression identification 900, in accordance with one embodiment of the present invention. Multiple ways are utilized to identify advertisement impressions or advertisements viewed by a customer 902. In some embodiments, the advertisements may be online, as illustrated in block 904. In other embodiments, the advertisements may be offline, as illustrated in block 906. For online advertisements 904, the system may determine that a customer has viewed the advertisement based on advertisement impression identification factors such as customer selecting or clicking on the advertisement 908, the customer scrolling over the advertisement 912, the duration the customer is viewing the webpage with the advertisement 910, searches associated with the customer 914, the IP address of the customer 915, and/or social network endorsements 916.

In some embodiments, a customer may select or click on the advertisement 908. In this way, the customer may select the advertisement to get more information about the product or merchant associated with the advertisement, print the advertisement, or the like. In this way, there is a high probability that an advertisement impression arose from the customer selecting the advertisement, thus the advertisement is identified as a customer advertisement impression. In some embodiments, the customer may spend a long period of time viewing the advertisement 910. The amount of time the customer is viewing an advertisement may be recognized when a customer is viewing the webpage and/or the advertisement on the webpage. If a customer is identified as viewing a webpage for a duration of time, a determination of the one or more advertisements on that page is made. The duration of time may vary depending on the page. However, if the duration of the customer's time on the webpage is longer, that is an indication that the customer has viewed the advertisements on that webpage. In this way there is a high probability that an advertisement impression arose during the time the customer was on the webpage. In some embodiments, the customer may scroll over the advertisement 912. The scrolling may occur with a curser, icon, finger, touch, eye recognition, or the like. In this way, it may be recognized that the customer is scrolling across or stopping on the advertisement on a webpage. This scrolling may be an indication that the customer has viewed the advertisement on the webpage. As such, there may be a higher probability that an advertisement impression arose during the scrolling period. In some embodiments, the customer may input search criteria into a webpage, search engine, or the like 914. In some embodiments, a customer may search for an advertisement, merchant, or product. The searching may lead to one or more advertisements being presented to the customer based on his/her search. As such, the advertisement may be viewed by the customer. The search may indicate an advertisement impression arose during the searching or results of the search. Next, in some embodiments, advertisement impressions may be identified by social network indicators 916. In this way, a customer may be presented with advertisements on his/her social network. The customer may also endorse advertisement via his/her social network. When a customer is presented with an advertisement on his/her social network or endorses an advertisement on a social network a customer advertisement impression may have been created. Finally, an advertisement impression may be created based on indications from the customer's online activity based on his/her IP address 915. In this way, the system may track previously selected, viewed, or presented advertisement that may indication a customer advertisement impression.

In some embodiments, the advertisements viewed may be offline, as illustrated in block 906. Offline advertisement impression identification factors may include subscriptions 918 to newspapers, flyers, magazines, and the like, television guides 922, global positioning systems 920, and/or travel purchases 924.

In some embodiments, the customer may view advertisements based on a subscription 918 to a newspaper, magazine, flyers, brochures, or the like. In this way, one or more subscriptions associated with the customer may be identified. Furthermore, it may be determined that he/she may review the contents of the subscription based on the subscription. As such, any advertisements that may be contained in the subscribed article may be viewed by the customer, thus may be included in an advertisement impression for that customer. In some embodiments, the customer may view billboards and the like associated with traveling. In this way, the system may utilize GPS 920 and/or travel purchases 924 to determine advertisements that may have been viewed by the customer. As such, GPS data may provide an indication as to the road, location, and the like that the customer is on. In this way, it is possible that one or more billboards on that road or in that location may have been viewed by the customer during his/her traveling. As such, these advertisements may be included in the advertisement impressions for the customer. Furthermore, the customer may transaction for various items during traveling, in the form of travel purchase 924. These purchases may be at train/bus stations, gas stations, airports, or the like. Based on these identified purchases, a determination of one or more advertisements that the customer may have viewed to include in his/her advertisement impressions may be made. Finally, commercials may be identified that include advertisements based on television channels and television guide systems 922. In this way, various advertisements in the form of a television commercial may be viewed by the customer, which may be included in his/her advertisement impressions.

Referring back to FIG. 8, as illustrated in block 804, the products of the viewed advertisements are retrieved by the system. In this way, the brand, type, product number, or the like is identified for the product of the transaction. As illustrated in block 806, the merchant providing the advertisements viewed are also retrieved by the system. The merchant may be the entity providing the advertisement, selling the product, or the like. The product and/or merchant may be identified and retrieved based on the advertisement itself. In some embodiments, the system may retrieve, store, and maintain information about the location of advertisements. These locations may be online, such as on a website or the like. These locations may also be offline, such as on a billboard, in a newspaper, in a magazine, or the like. In this way, the system may identify that an advertisement is being viewed by the customer, and correlate the location of the customer with the location of the advertisement to identify the advertisement being viewed. For example, the customer may be on a specific website. The system may retrieve the advertisement on that website as being viewed by the customer. The system may also have stored or receive data (from the website provider) that the advertisement that was associated with that customer's IP address, at that time, on that website location was for Product A provided by Merchant A. In some embodiments, the system could receive information that a customer viewed a billboard based on the customer's travel route. In this way, the system may know what advertisement is on which billboard on the customer's route. In this way, the system may receive an illustration, digital representation, photo, or the like of the advertisement and recognize barcodes, quick response codes (QR), names, brands, product numbers, or other identifiers on the advertisement. The system may receive the advertisement via online searching or reviewing of the webpage a customer is viewing, receiving offline advertisements, or the like. Furthermore, the advertisement viewed information may include data about the time and date the advertisement was viewed, the channel of viewing, the duration of viewing the advertisement, and/or the number of times a customer viewed the advertisement retrieved from an advertiser or merchant.

Next, as illustrated in block 808, the process 800 continues by retrieving transaction data associated with the customer. In this way, the system may receive item level data from SKU level data received and/or data from electronic communications between a customer and merchant. This data may, in some embodiments, be matched to transaction data associated with customer accounts at the financial institution. Based on the received SKU level data and/or the data from electronic communications between a customer and a merchant, the system may be able to identify item level transaction data for the transactions. In this way, the system may identify the product and/or the model, type, manufacturer, brand, or the like associated with the product. Furthermore, the merchant of the transaction and associated with the product may be identified as part of the item level transaction data.

As illustrated in block 810, the system may match the item level transaction data to one or more products of the advertisements viewed by that customer. As illustrated in block 812, the system may match item level transaction data to one or more merchants associated with the advertisements viewed by that customer.

Next, as illustrated in block 814, the process 800 continues by compiling the matched data for products and merchants that match between the advertisements viewed and item level transaction data for advertisement feedback. This data is compiled for marketing or advertising campaigns. Next, as illustrated in block 816 the feedback is presented to the advertisers or merchants requesting the data.

In some embodiments, feedback is provided to an advertiser based on the match along with the feedback for future advertisements in the form of advertisement correlation data. The feedback based on a match may include an amount of customers that viewed the advertisement compared to an amount of customers that purchased the products associated with that advertisement. Not only will the system provide information regarding which advertisements may be positive resulting and which are not, such that the merchant may determine the most positive advertisement campaign based on this data. The system may also provide feedback for future advertisement predictions in the form of advertisement correlation data.

In some embodiments, the system generates and provides marketing effectiveness data based on the match data and advertisement correlation data. As such, the invention generates marketing effectiveness data that tracks the advertisements and the effectiveness of the advertisements based on purchases associated with advertisement impressions and aids in predicting future marketing strategy and advertisement focusing. Along with this, the system bridges an important advertising gap between an advertisement and a subsequent brink and mortar store purchase.

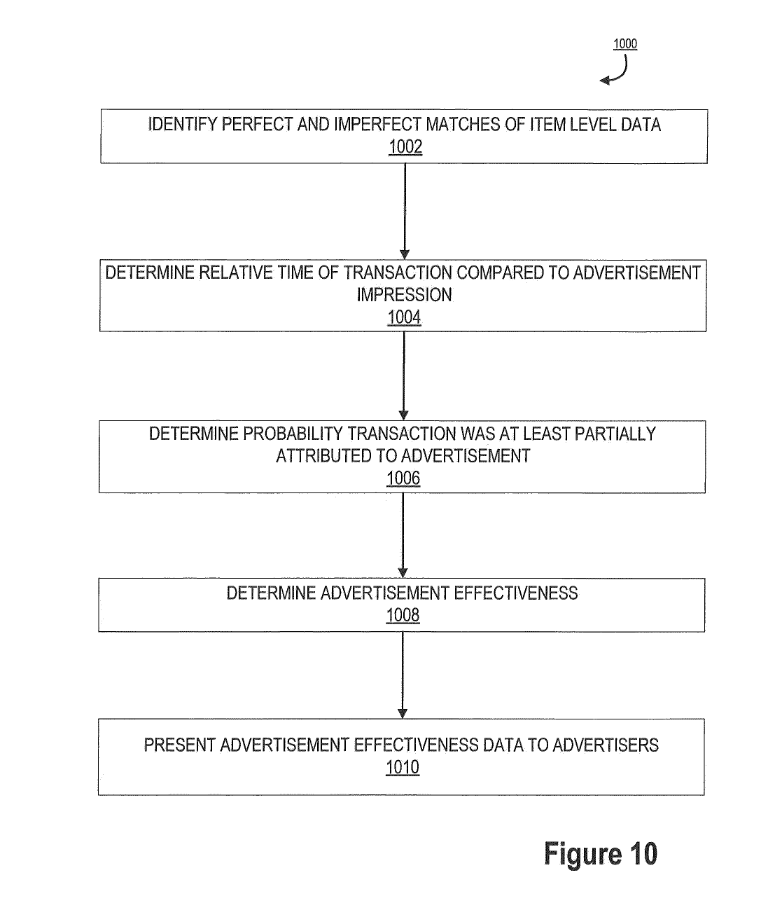

FIG. 10 illustrates a process flow for perfect and imperfect matching of item level transaction data with viewed advertisement for marketing effectiveness tracking 1000, in accordance with one embodiment of the present invention. As illustrated in block 1002, the process 1000 is initiated when perfect and imperfect matches of item level data are identified. In this way, item level data from customer/merchant communications and SKU level data may be matched to advertisements viewed by the customer. In some embodiments, the matches are perfect between the item viewed and the item purchased. However, in other embodiments, the matches are for similar products, but imperfect.

Next, as illustrated in block 1004, the process 1000 continues by determining the time of the transaction compared to the time of the advertisement impression. In this way, a time frame is established from the point of viewing the advertisement to the point of the transaction. In some embodiments, a time frame is established from the point of the transaction to the point of viewing the advertisement, if the advertisement viewing came after the transaction. As such, this time frame is utilized to further identify and at least partially attribute the purchase to the advertisement viewed. In some embodiments, a short time frame indicates an effective advertisement while a longer time frame indicates a less effective advertisement. In some embodiments, a time stamp is put on the advertisement when an advertisement is viewed by a customer. In some embodiments, a time stamp is also put on a transaction when the transaction is completed. The time range between the two time stamps is the determined time frame.

Next, as illustrated in block 1006, the system may determine the probability that the transaction was at least partially attributed to the advertisement viewed. In this way, the system takes into account the likelihood that the advertisement was viewed, whether the match was perfected, and the time frame between the advertisement and the transaction in order to provide a confidence rating or probability of the advertisement success.

In some embodiments, the likelihood that the advertisement was viewed is taken into consideration by the system to predict the advertisement success. The likelihood of the advertisement was viewed is dependent on the confidence in the advertisement impression identification. The system may provide high confidence for selecting or clicking the advertisement, longer duration of viewing, social network, search results, or the like. While lower confidence, without other factors, may be applied to scrolling over the advertisement, IP address, subscriptions, GPS travel purchase, and television guides. The system may also learn, based on positive and negative results of matches, the more likely higher confidence advertisement impression identifiers as the system makes more and more matches.

In some embodiments, whether the match between the advertisement viewed and the product purchased was perfect or imperfect is taken into consideration by the system to predict the advertisement success. In some embodiments, a perfected match reflects a positive or successful advertisement. In some embodiments, an imperfect match reflects a neutral or negative advertisement. In some embodiments, the time frame between the advertisement and a transaction is taken into consideration by the system to predict the advertisement success. In some advertisements the time frame between the advertisement and transaction is critical because the advertisement is time sensitive. In other embodiments, a shorter time frame may indicate a more successful advertisement, while a longer time frame may indicate a negative advertisement. Finally, based on the likelihood that the advertisement was viewed, whether the match was perfected, and the time frame between the advertisement and the transaction a confidence score or probability that one or more transactions are associate or attributed to one or more advertisements viewed by the customer is determined.

Next, as illustrated in block 1008, the process 1000 continues by determining the advertisement effectiveness based on the probability. In this way, the system compiles data from multiple customers to determine an overall effectiveness of the advertisement relative to other advertisements, a base line, a goal effectiveness rating, or the like. As such, the system may also generates and provides marketing effectiveness data based on the correlation between the advertisement being viewed by the customer and a transaction for the products associated with the advertisement along with future advertisement data in the form of advertisement correlation data, explained in further detail above in FIG. 1 and FIG. 7. As such, the invention generates feedback for marketing effectiveness data and future advertisements in the form of advertisement correlation data.

Finally, as illustrated in block 1010 the advertisers are presented with the feedback, including advertisement effectiveness data associated with their advertisements. The system may provide the data, probabilities, confidence scores, number of customers sampled, and the like. In this way, the system generates and provides marketing effectiveness data based on the correlation between the advertisement being viewed by the customer and a transaction for the products associated with the advertisement.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for advertisement presentment, the system comprising:
a memory device with non-transitory computer-readable program code stored thereon;
a communication device;
a processing device operatively coupled to the memory device and the communication device, wherein the processing device is configured to execute the computer-readable program code to:
receive transaction data associated with a customer transaction, wherein the received customer transaction data includes SKU data and/or electronic communication data from electronic communications between a merchant and the customer;
identify item level data for products of the transaction, wherein item level data includes specific information identifying a product including a model number, name, and manufacturer of the product of the transaction;
compile the item level data across a financial institution;
generalize the item level data across the financial institution based on a category of product and/or category of merchant;
receive a request for advertisement correlation data from an advertiser, wherein the advertisement correlation data includes the generalized item level based on the category of product and/or category of merchant;
match the generalized item level data to the request; and
present feedback for future advertisements based on the request for advertisement correlation data.

2. The system of claim 1, wherein the processing device is further configured to execute the computer-readable program code to:
receive information indicating one or more advertisements for a merchant, product, and/or service viewed by a customer;
identify the product and merchant of the advertisement viewed;
match the merchant, product, and/or service of the one or more advertisements viewed by the customer to the item level transaction data; and
provide advertising effectiveness data including feedback indicating successfulness of advertisements based on a match between the viewed advertisements and item level data from the customer transactions.

3. The system of claim 1, wherein receiving electronic communication data includes monitoring email addresses of the customer and the merchant to identify electronic communications associated with transactions and retrieving the electronic communication data.

4. The system of claim 1, wherein generalizing the item level data across the financial institution based on a category of product and merchant includes removing customer information from the item level data and correlating each of the products of each of the transactions for the item level data into a category of product and/or by merchant associated with the transaction.

5. The system of claim 1, further comprising matching the item level data for products of the transaction identified by the received transaction data to financial account data received at the financial institution for processing the transaction.

6. The system of claim 1, wherein presenting feedback for future advertisements based on the request for advertisement correlation data further comprises providing an interactive interface for advertisement searching of generalized item level data to predict future transactions of customers and target advertisements based on the generalized item level data.

7. The system of claim 2, wherein receiving information indicating one or more advertisements for a merchant, product, and/or service viewed by the customer further comprises receiving information identifying that the customer viewed at least one online advertisement by identifying customer selected advertisements, a duration of viewing a webpage with advertisements, scrolling over advertisements during an online session, identifying online search queries, or social network endorsements of the customer.

8. The system of claim 2, wherein matching the merchant, product, and/or service of the one or more advertisements viewed by the customer to transactions completed by the customer further comprises identifying perfect matches and imperfect matches, wherein perfect matches are a same merchant, product, and/or service associated with a transaction of the customer and the at least one advertisement viewed by the customer and imperfect matches are a similar merchant, product, and/or service of a customer transaction and the at least one advertisement viewed by the customer.

9. The system of claim 2, wherein providing advertising effectiveness data including providing a confidence associated with a success of the at least one advertisement based on a likelihood that the at least one advertisement was viewed by the customer, a perfect or imperfect match of products of the at least one advertisement and the transaction, and a time frame between the at least one advertisement for the product and the transaction for the product in a viewed advertisement.

10. A computer program product for advertisement presentment, the computer program product comprising at least one non-transitory computer-readable medium having computer-readable program code portions embodied therein, the computer-readable program code portions comprising:
an executable portion configured for receiving transaction data associated with a customer transaction, wherein the received customer transaction data includes SKU data and/or electronic communication data from electronic communications between a merchant and the customer;
an executable portion configured for identifying item level data for products of the transaction, wherein item level data includes specific information identifying a product including a model number, name, and manufacturer of the product of the transaction;
an executable portion configured for compiling the item level data across a financial institution;
an executable portion configured for generalizing the item level data across the financial institution based on a category of product and/or category of merchant;
an executable portion configured for receiving a request for advertisement correlation data from an advertiser, wherein the advertisement correlation data includes the generalized item level based on the category of product and/or category of merchant;
an executable portion configured for matching the generalized item level data to the request; and
an executable portion configured for presenting feedback for future advertisements based on the request for advertisement correlation data.

11. The computer program product of claim 10, further comprising:
an executable portion configured for receiving information indicating one or more advertisements for a merchant, product, and/or service viewed by a customer;
an executable portion configured for identifying the product and merchant of the advertisement viewed;
an executable portion configured for matching the merchant, product, and/or service of the one or more advertisements viewed by the customer to the item level transaction data; and
an executable portion configured for providing advertising effectiveness data including feedback indicating successfulness of advertisements based on a match between the viewed advertisements and item level data from the customer transactions.

12. The computer program product of claim 10, wherein receiving electronic communication data includes monitoring email addresses of the customer and the merchant to identify electronic communications associated with transactions and retrieving the electronic communication data.

13. The computer program product of claim 10, wherein generalizing the item level data across the financial institution based on a category of product and merchant includes removing customer information from the item level data and correlating each of the products of each of the transactions for the item level data into a category of product and/or by merchant associated with the transaction.

14. The computer program product of claim 10, further comprising matching the item level data for products of the transaction identified by the received transaction data to financial account data received at the financial institution for processing the transaction.

15. The computer program product of claim 10, wherein presenting feedback for future advertisements based on the request for advertisement correlation data further comprises providing an interactive interface for advertisement searching of generalized item level data to predict future transactions of customers and target advertisements based on the generalized item level data.

16. The computer program product of claim 11, wherein matching the merchant, product, and/or service of the one or more advertisements viewed by the customer to transactions completed by the customer further comprises identifying perfect matches and imperfect matches, wherein perfect matches are a same merchant, product, and/or service associated with a transaction of the customer and the at least one advertisement viewed by the customer and imperfect matches are a similar merchant, product, and/or service of a customer transaction and the at least one advertisement viewed by the customer.

17. A computer-implemented method for advertisement presentment, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
receiving transaction data associated with a customer transaction, wherein the received customer transaction data includes SKU data and/or electronic communication data from electronic communications between a merchant and the customer;
identifying item level data for products of the transaction, wherein item level data includes specific information identifying a product including a model number, name, and manufacturer of the product of the transaction;
compiling the item level data across a financial institution;
generalizing, via a computer device processor, the item level data across the financial institution based on a category of product and/or category of merchant;
receiving a request for advertisement correlation data from an advertiser, wherein the advertisement correlation data includes the generalized item level based on the category of product and/or category of merchant;
matching the generalized item level data to the request; and
presenting feedback for future advertisements based on the request for advertisement correlation data.

18. The computer-implemented method of claim 17, wherein the processing device is further configured to execute the computer-readable program code to:
receive information indicating one or more advertisements for a merchant, product, and/or service viewed by a customer;
identify the product and merchant of the advertisement viewed;
match the merchant, product, and/or service of the one or more advertisements viewed by the customer to the item level transaction data; and
provide advertising effectiveness data including feedback indicating successfulness of advertisements based on a match between the viewed advertisements and item level data from the customer transactions.

19. The computer-implemented method of claim 17, wherein receiving electronic communication data includes monitoring email addresses of the customer and the merchant to identify electronic communications associated with transactions and retrieving the electronic communication data.

20. The computer-implemented method of claim 17, further comprising matching the item level data for products of the transaction identified by the received transaction data to financial account data received at the financial institution for processing the transaction.

21. The computer-implemented method of claim 17, wherein presenting feedback for future advertisements based on the request for advertisement correlation data further comprises providing an interactive interface for advertisement searching of generalized item level data to predict future transactions of customers and target advertisements based on the generalized item level data.

22. The computer-implemented method of claim 18, wherein matching the merchant, product, and/or service of the one or more advertisements viewed by the customer to transactions completed by the customer further comprises identifying perfect matches and imperfect matches, wherein perfect matches are a same merchant, product, and/or service associated with a transaction of the customer and the at least one advertisement viewed by the customer and imperfect matches are a similar merchant, product, and/or service of a customer transaction and the at least one advertisement viewed by the customer.
